(19) United States
(12) Patent Application Publication
(10) Pub. No.: US 2024/0188017 A1
(43) Pub. Date: Jun. 6, 2024

(54) METHOD FOR REPORTING TIMING ADVANCE BY TERMINAL DEVICE IN NTN, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN)

(73) Assignee: GUANGDONG OPPO MOBILE TELECOMMUNICATIONS CORP., LTD., Dongguan (CN)

(21) Appl. No.: 18/439,576

(22) Filed: Feb. 12, 2024

Related U.S. Application Data
(63) Continuation of application No. PCT/CN2021/128530, filed on Nov. 3, 2021.

(51) Int. Cl. H04W 56/00; H04W 74/0833; H04W 76/20; H04W 84/06

(52) U.S. Cl. CPC H04W 56/0045; H04W 74/0833; H04W 76/20; H04W 84/06

(57) ABSTRACT

A method of a terminal device reporting a Timing Advance TA in a Non Terrestrial Network NTN, a terminal device, and a network device are provided. The method includes triggering TA reporting, by the terminal device, in response to the terminal device in a Radio Access Control RRC connection state receiving a TA reporting event configuration/reconfiguration message from a network device, or receiving a TA reporting function configuration/reconfiguration message from the network device.

### CROSS REFERENCE TO RELATED APPLICATIONS

The present disclosure is a continuation of International Application No. PCT/CN2021/128530 filed Nov. 3, 2021, which is herein incorporated by reference in its entirety.

### TECHNICAL FIELD

The present disclosure relates to a field of communications, and in particular to a method of a terminal device reporting a Timing Advance (TA) in a Non Terrestrial Network (NTN), a terminal device, and a network device.

### BACKGROUND

In the NTN, in order to assist a network to perform a K-offset configuration for a User Equipment (UE), a mechanism of the UE reporting the TA is introduced to the NTN.

For the TA reporting, the following conclusion has been developed currently.

Whether the UE is able to report the TA in an initial Random Access Channel (RACH) process depends on a network configuration. The network configures this indication information by means of broadcasting. For UEs in a Radio Resource Control (RRC) connection state, an event- triggering TA reporting mechanism is supported. Currently-agreed triggering events for the TA reporting include the network configuring a TA offset threshold, and the UE triggering the TA reporting in response to the variation of a current TA value of the UE compared to a TA value which is successfully reported at last time exceeding the TA offset threshold.

Based on the conclusions of current meetings, for event-triggering TA reporting, the UE is required to compare the current TA value with a lastly-reported TA value to determine whether to trigger the TA reporting. How to trigger the TA reporting under this TA reporting mechanism is a problem required to be solved.

### SUMMARY OF THE DISCLOSURE

Embodiments of the present disclosure provide a method of a terminal device reporting a

Timing Advance (TA) in a Non Terrestrial Network (NTN), a terminal device, and a network device.

According to a first aspect of the embodiment of the present disclosure, a method of a terminal device reporting a Timing Advance TA in a Non Terrestrial Network NTN is provided. The method includes triggering TA reporting, by the terminal device, in response to the terminal device in a Radio Access Control RRC connection state receiving a TA reporting event configuration/reconfiguration message from a network device, or receiving a TA reporting function configuration/reconfiguration message from the network device.

According to a second aspect of the embodiments of the present disclosure, method of a terminal device reporting a Timing Advance TA in a Non Terrestrial Network NTN is provided. The method includes transmitting, by a network device, a TA reporting event configuration/reconfiguration message, or a TA reporting function configuration/reconfiguration message to a terminal device in a Radio Access Control RRC connection state, wherein the TA reporting event configuration/reconfiguration message is configured for the terminal device to trigger TA reporting based on a TA reporting event, and the TA reporting function configuration/reconfiguration message is configured for the terminal device to trigger the TA reporting based on a TA reporting function.

According to a third aspect of the embodiments of the present disclosure, a terminal device is provided and includes a memory, storing executable program codes; and a processor, coupled to the memory, and configured to trigger TA reporting in response to the terminal device in a Radio Access Control RRC connection state receiving a TA reporting event configuration/reconfiguration message from a network device, or receiving a TA reporting function configuration/reconfiguration message from the network device.

According to a fourth aspect of the embodiments of the present disclosure, a network device is provided and includes a memory, storing executable program codes; and a transceiver, coupled to the memory, and configured to transmit a TA reporting event configuration/reconfiguration message, or a TA reporting function configuration/reconfiguration message to a terminal device in a Radio Access Control RRC connection state, wherein the TA reporting event configuration/reconfiguration message is configured for the terminal device to trigger TA reporting based on a TA reporting event, and the TA reporting function configuration/reconfiguration message is configured for the terminal device to trigger the TA reporting based on a TA reporting function.

### BRIEF DESCRIPTION OF THE DRAWINGS

FIG. 1 is a schematic diagram of a satellite network architecture of transparent payload.

FIG. 2 is a schematic diagram of a satellite network architecture of regenerative payload.

FIG. 3A is a schematic view of time synchronization at a gNB side in prior arts.

FIG. 3B is another schematic view of the time synchronization at the gNB side in the prior arts.

FIG. 4 is a schematic view of a timing relationship in a Non Terrestrial Network (NTN) system.

FIG. 5 is a further schematic view of the timing relationship in the NTN system.

FIG. 6 is a system architecture diagram of a communication system applied in embodiments of the present disclosure.

FIG. 7 is a schematic view of a method of a terminal device reporting a timing advance in a NTN according to an embodiment of the present disclosure.

FIG. 8A is a schematic view of the terminal device reporting the timing advance in the NTN according to some embodiments of the present disclosure.

FIG. 8B is a further schematic view of the terminal device reporting the timing advance in the NTN according to some embodiments of the present disclosure.

FIG. 9 is a schematic view of the terminal device according to an embodiment of the present disclosure.

FIG. 10 is a schematic view of a network device according to an embodiment of the present disclosure.

FIG. 11 is a schematic view of the terminal device according to another embodiment of the present disclosure.

FIG. 12 is a schematic view of the network device according to another embodiment of the present disclosure.

### DETAILED DESCRIPTION

The technical solution of the embodiments of the present disclosure will be described below in conjunction with accompanying drawings in the embodiments of the present disclosure. Apparently, described embodiments are a part but not all of the embodiments of the present disclosure. Other embodiments obtained by one of ordinary skill in the related art based on the embodiments of the present disclosure without creative labor shall all fall into the scope of the present disclosure.

Some terms involved in the present disclosure are briefly illustrated at first in the following.

1. Non Terrestrial Network (NTN) related background

Currently, the 3rd Generation Partnership Project (3GPP) is searching NTN technologies. The NTN generally provides communication services for ground users in a manner of the satellite communication. Compared with ground cellular network communication, the satellite communication has many unique advantages. Firstly, the satellite communication is not limited by a geographical area of a user. For example, a general terrestrial communication cannot cover an area in which a communication equipment cannot be set up, such as ocean, a mountain, a desert, etc., or an area in which the communication equipment is not set up due to sparse populations. However, for the satellite communication, since one satellite may cover a large area ground and may move orbitally around the Earth. Therefore, in theory, every corner of the earth may be covered by the satellite communication. Secondly, the satellite communication has a greater society value. The satellite communication may cover a remote mountainous area, a poor and backward country or area with a lower cost, such that users in these areas may enjoy advanced voice communication and mobile Internet technologies, which is conducive to narrowing a digital divide with developed areas and promoting the development of these areas. Thirdly, a distance of the satellite communication is long, and a communication cost is not staggering increased with an increase communication distance. Finally, the satellite communication has a high stability and frees from limitations of natural disasters.

Communication satellites may be divided into a low-Earth orbit (LEO) satellite, a medium- Earth orbit (MEO) satellite, a geosynchronous orbit (GEO) satellite, a high elliptical orbit (HEO) satellite, etc., according to different orbit altitudes. The LEO and GEO are primarily studied in the related art.

For the LEO satellite, an altitude range of an orbit of the LEO satellite is 500 km-1500 km, and a corresponding orbital period ranges approximately from 1.5 hours to 2 hours. A signal propagation delay of a single hop communication between terminal devices is generally less than 20 ms. The maximum satellite visualization time is 20 minutes. A signal propagation distance is short, a link loss is low, and a requirement for a transmitting power of the terminal device is not high.

For the GEO satellite, an orbit altitude of the GEO satellite is 35786 km, a period of rotating around the Earth is 24 hours. A signal propagation delay of a single hop communication between the users is generally 250 ms.

In order to ensure the coverage of the satellite and increase a system capacity of a whole satellite communication system, the satellite employs multiple beams to cover the ground. One satellite may form dozens or even hundreds of beams to cover the ground. One satellite beam may cover a ground area having a diameter ranging from tens to hundreds of kilometers.

2. Satellite network architecture

Currently, the 3GPP considers two kinds of satellites. One is satellites of transparent payload, the other one is satellites of regenerative payload.

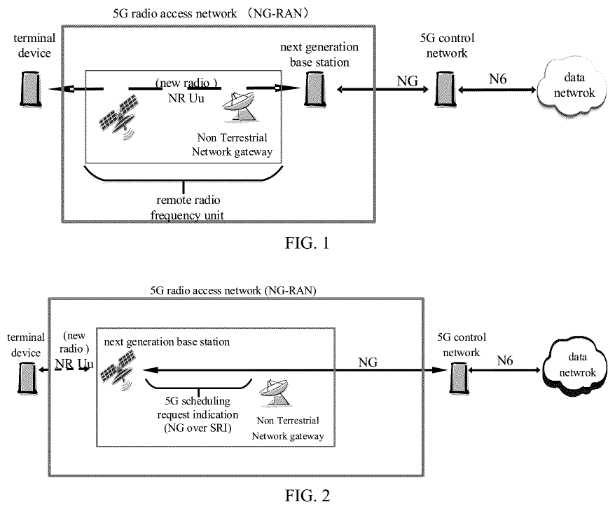

As shown in FIG. 1, FIG. 1 is a schematic diagram of a satellite network architecture of the transparent payload. As shown in FIG. 2, FIG. 2 is a schematic diagram of a satellite network architecture of the regenerative payload. A feeder link refers to a radio link between the satellite and a NTN gateway.

3. New Radio (NR) uplink timing advance

An important feature of uplink transmissions is different UEs orthogonally multiple-access accessing on a time frequency. That is, uplink transmissions of the UEs from a same cell do not interrupt each other.

In order to ensure orthogonality of the uplink transmissions and avoid intra-cell interferences, a new generation NodeB (gNB) requires that times of signals of different UEs from the same moment but different frequency resources arriving at the gNB basically align to each other. In order to ensure time synchronization at the gNB side, the NR supports an uplink timing advance mechanism.

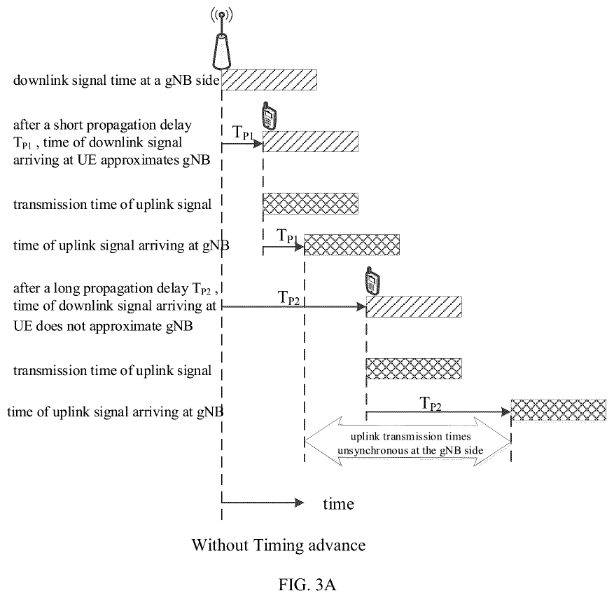

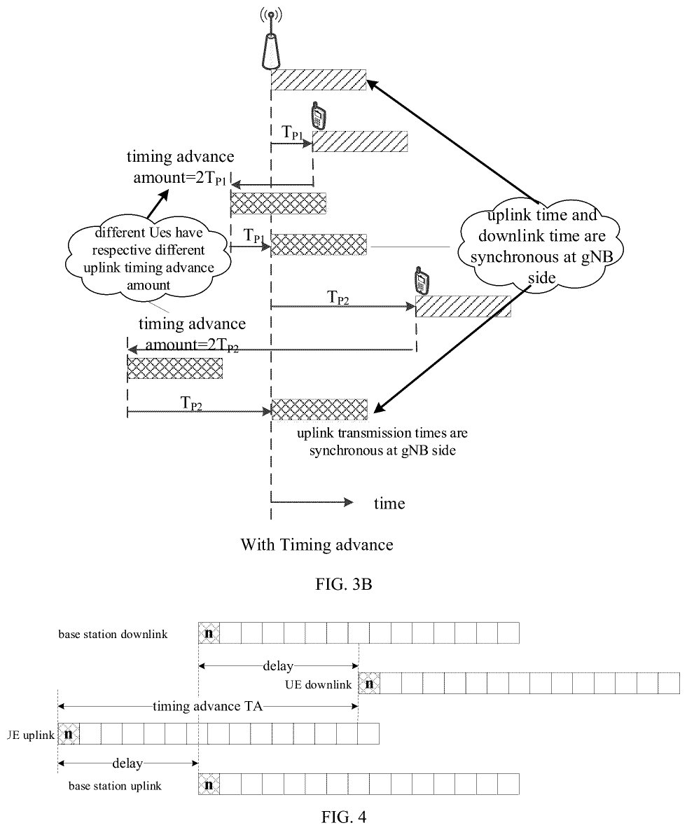

An uplink clock and a downlink clock at the gNB side are the same, while an uplink clock and a downlink clock at a UE side have an offset. In addition, different UEs have respective different uplink timing advance amount. The gNB may controls times of uplink signals from different UEs arriving at the gNB through appropriately controlling an offset of each UE. UEs farther away from the gNB are required to transmit uplink data in advance than those closer to the gNB due to lager transmission delays. As shown in FIG. 3A, FIG. 3A is a schematic view of time synchronization at the gNB side in the prior arts. As shown in FIG. 3B, FIG. 3B is another schematic view of the time synchronization at the gNB side in the prior arts.

The gNB determines a TA value of each UE based on measuring the uplink transmission of the UEs. The gNB transmits TA commands to the UEs in two ways (1) and (2).

(1) Initial Timing Advance (TA) acquisition: in a random access process, the gNB determines the TA through measuring a received random preamble, and transmits the TA value to the UE through an uplink timing advance command field.

(2) Adjustment of a RRC connection state TA: although the UE and the gNB acquire uplink synchronization in the random access process, timing of the uplink signals arriving at the gNB may change over time. Therefore, the UE is required to continuously update an uplink timing advance of the UE to maintain THE uplink synchronization. If a TA of a particular UE is required to be corrected, the gNB transmits a Timing Advance Command to this UE to request this UE to adjust its uplink timing. The Timing Advance Command is transmitted to the UE via the Timing Advance Command Medium Access Control (MAC) Control Element (CE). 4. A timing relationship in a NTN System

In a terrestrial communication system, a propagation delay of a signal communication is typically less than 1 millisecond (ms). In the NTN system, due to a long communication distance between a terminal device and a satellite (or a network device), a propagation delay of a signal communication is large, ranging from tens of milliseconds to hundreds of milliseconds, which depends on an orbital altitude of the satellite and a service type of a satellite communication. In order to handle a larger propagation delay, the timing relationship of the NTN system is required to be enhanced relative to a NR system.

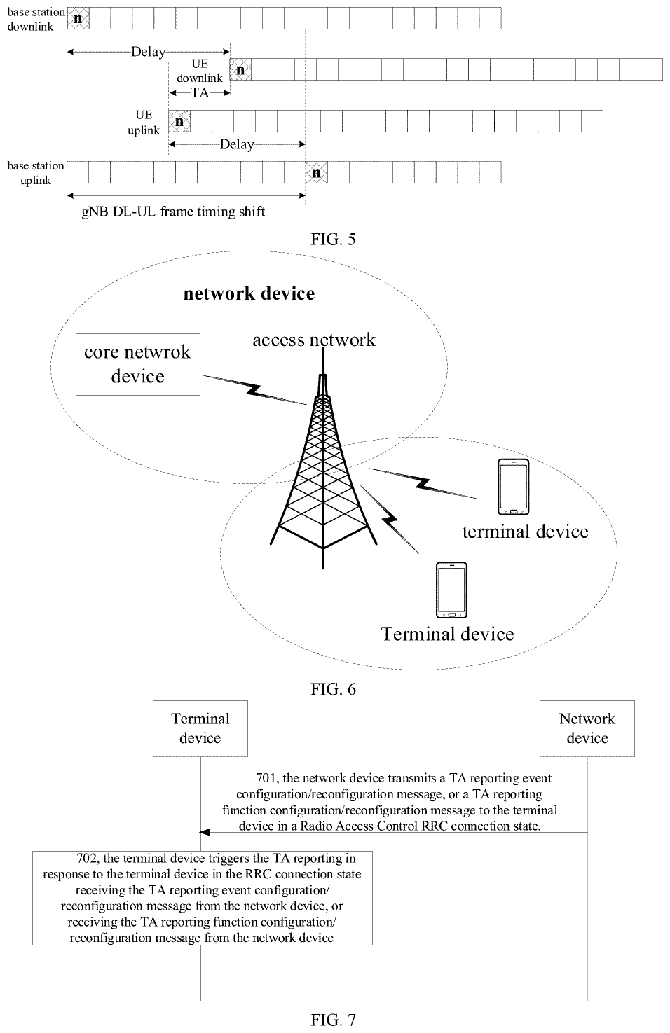

In the NTN system, as the NR system, the UE is required to consider an effect of the TA during performing an uplink transmission. Since the propagation delay in the system is larger, a range of the TA is also larger. When the UE is scheduled to perform the uplink transmission in a time slot n, the UE considers a round-trip propagation delay and performs a transmission in advance during the uplink transmission. In this way, when a signal arrives at a base station side, the signal may be on a time slot n of a base station side uplink, as shown in FIGS. 4 and 5, FIGS. 4 and 5 are schematical views of the timing relationship of the NTN system.

A case 1 is as shown in FIG. 4, as the NR system, a downlink time slot and an uplink time slot at the base station side are aligned. Accordingly, in order to align the uplink transmission of the UE with the uplink time slot of the base station side, the UE is required to employ a lager TA value. When performing the uplink transmission, a lager offset value, such as a K offset, is also required to be introduced.

A case 2 is shown in FIG. 5, an offset value exists between the downlink time slot and the uplink time slot at the base station side. In this case, for making the uplink transmission of the UE to be aligned with the uplink time slot at the base station side, the UE is simply required to employ a smaller TA value. However, in this case the base station may be required to additionally schedule complexity to process a corresponding scheduling time sequence.

5. time sequence relationships in the NR system Time sequence relationships in existing NR systems are as follows.

A Physical Downlink Shared Channel (PDSCH) receives a time sequence: when the UE is scheduled to receive the PDSCH by Downlink Control Information (DCI), the DCI includes indication information of K₀, and K₀ is configured to determine a time slot for transmitting the PDSCH. For example, if the scheduling DCI is received on the time slot n, a time slot allocated for a transmission of the PDSCH is a time slot

$$⌊ n \cdot \frac{{2}^{{μ}_{PDSCH}}}{{2}^{{μ}_{PDCCH}}} ⌋ + {K}_{0} .$$

K₀ is determined based on a subcarrier spacing of the PDSCH. μ_{PDSCH} and μ_{PDCCH} are respectively configured to determine subcarrier spacings configured for the PDSCH and a Physical Downlink Control Channel (PDCCH). A value of K₀ ranges from 0 to 32.

A transmission time sequence of the PUSCH scheduled by the DCI: when the UE is scheduled by the DCI to transmit the PUSCH, the DCI includes indication information of K₂. K₂ is configured to determine a time slot for transmitting the PUSCH. For example, when the schedule DCI in received in the time slot n, a time slot allocated for a PUSCH transmission is a time slot

$$⌊ n \cdot \frac{{2}^{{μ}_{PUSCH}}}{{2}^{{μ}_{PDCCH}}} ⌋ + {K}_{2} .$$

K₂ is determined based on a subcarrier spacing of the PDSCH. μ_{PUSCH} and μ_{PDCCH} are respectively configured to determine subcarrier spacings configured for the PUSCH and the PDCCH. A value of K₂ ranges from 0 to 32.

A transmission time sequence of the PUSCH scheduled by a RAR grant: for a time slot scheduled by the RAR Grant for performing the PUSCH transmission, if after the UE initiates a Physical Random Access Channel (PRACH) transmission, an end position of a PDSCH including a corresponding RAR grant message received by the UE is on the time slot n, then the UE transmits the PUSCH on a time slot n+K₂+Δ. K₂ and Δ are protocol agreed.

A transmission time sequence of hybrid automatic repeat request acknowledgement

(HARQ-ACK) information on a Physical Uplink Control Channel (PUCCH): for a time slot of a PUCCH transmission, if an end position of a PDSCH reception is on the time slot n or an end position of a PDCCH reception indicating a release of a Semi-Persistent Scheduling (SPS) PDSCH is on the time slot n, UE should transmit corresponding HARQ-ACK information on a PUCCH resource in a time slot n+K1. K1 is the number of time slots. K₁=0 is indicated through a PDSCH- to-HARQ-timing-indicator information domain in a DCI format or is provided through a dl- Data ToUL-ACK parameter. corresponds to the latest time slot of the PUCCH transmission being overlapping with a time slot of the PDSCH reception or the PDCCH reception indicating the release of the SPS PDSCH.

MAC CE activating time sequence: when the HARQ-ACK information corresponding to the PDSCH including a MAC CE command is transmitted on the time slot n, a corresponding behavior indicated by the MAC CE command and a downlink configuration assumed by the UE should take effect from the first time slot after a time slot n+3Nₛₗₒₜ^{subframe,μ}. Nₛₗₒₜ^{subframe,μ} indicates the number of time slots included in each subframe under a subcarrier spacing configuration μ.

A Channel State Information (CSI) transmission sequence on the PUSCH: the CSI transmission time sequence on the PUSCH is in general the same as a transmission time sequence of the DCI scheduling the PUSCH transmission.

A CSI reference resource time sequence: a CSI reference resource reporting CSI on an uplink time slot n′ is determined based on a single downlink time slot

$$n - {n}_{CSI \_ ref} \cdot n = ⌊ {n}^{′} \cdot \frac{{2}^{{μ}_{DL}}}{{2}^{{μ}_{UL}}} ⌋ .$$

μ_{DL} and μ_{UL} are subcarrier spacing configurations of the downlink and the uplink, respectively. A value of n_{CSI_ref} depends on a type of CSI reporting.

An aperiodic channel Sounding Reference Signal (SRS) transmission time sequence: if the UE receives a DCI on the time slot n triggering to transmit an aperiodic SRS, the UE transmits aperiodic SRSs in each triggered SRS resource set on a time slot

$$⌊ n \cdot {2}^{\frac{{μ}_{SRS}}{{μ}_{PDCCH}}} ⌋ + k .$$

k is configured through a high layer parameter slot offset in each triggered SRS resource set and is determined based on a subcarrier spacing corresponding to a triggered SRS transmission. μ_{SRS} and μ_{PDCCH} are subcarrier spacing configurations of the triggered SRS transmission and the PDCCH carrying a triggering command, respectively.

6. A time sequence enhancement in the NTN system

A PDSCH reception time sequence in the NR system is only affected by a time sequence at a downlink receiving side, and is not affected by a large transmission round-trip delay in the NTN system. Therefore, the NTN system may reuse the PDSCH reception time sequence in the NR system.

For other time sequences alternatively affected by a downlink reception and an uplink transmission, in order to normally operate in the NTN system, or in order to overcome a large transmission delay in the NTN system, time sequence relationships are required to be enhanced. A simple solution is to introduce an offset parameter K_{offset} in the system and apply this parameter to a related time sequence relationship.

The transmission time sequence of the PUSCH (including the CSI transmitted on the PUSCH) scheduled by the DCI: if the scheduled DCI is received on the time slot n, a time slot allocated for the PUSCH transmission is a time slot

$$⌊ n \cdot \frac{{2}^{{μ}_{PUSCH}}}{{2}^{{μ}_{PDCCH}}} ⌋ + {K}_{2} + {K}_{offset} .$$

The transmission time sequence of the PUSCH scheduled by the RAR grant: for a time slot scheduled by the RAR grant for the PUSCH transmission, the UE transmits the PUSCH on a time slot n+K₂+Δ+K_{offset}.

The transmission time sequence of transmitting the HARQ-ACK on the PUCCH: for a time slot of the PUCCH transmission, the UE should transmit the corresponding HARQ-ACK information on the PUCCH resource in a time slot n+K₁+K_{offset}.

The MAC CE activating the time sequence: when the HARQ-ACK information corresponding to the PDSCH including the MAC CE command is transmitted on the time slot n, the corresponding behavior indicated by the MAC CE command and the downlink configuration assumed by the UE should take effect from the first time slot after a time slot n+XNₛₗₒₜ^{subframe,μ}+K_{offset}. X may be determined by a UE capability of the NTN, and a value of which may be not 3.

The CSI reference resource time sequence: the CSI reference resource reporting the CSI on the uplink time slot n′ is determined based on a single downlink time slot n-n_{CSI_ref}−K_{offset}.

An aperiodic SRS transmission time sequence: if the UE receives the DCI on the time slot n triggering to transmit the aperiodic SRS, the UE transmits the aperiodic SRSs in each triggered

$$⌊ n \cdot {2}^{\frac{{μ}_{SRS}}{{μ}_{PDCCH}}} ⌋ + k + {K}_{offset} .$$

SRS resource set on a time slot

Based on current progresses of 3GPP for NTN standardization, the following conclusions 1-3 have been formed for the configuration of the k offset. 1. for an initial random access process, the network may configure a cell-level k offset by means of broadcasting.

2. for a UE in a connection state, the network may configure an exclusive k offset for the UE via RRC signaling or a MAC.

3. if the network does not configure an exclusive k offset for the UE, the UE uses a broadcasted k offset.

Based on the current understanding, the network primarily refers to the TA to configure a value of the k offset value. For example, for a k offset broadcasted by the network, the network is required to configure the k offset based on the maximum TA supported within a cell range. For a k offset exclusive to the UE, the network may configure the k offset with reference to a TA of the UE.

As mentioned above, in a NTN network, the network is required to refer to the TA of the UE to configure the value of the k offset value. That is, the network is required to ensure that the k offset configured for the UE does not exceed the TA value of the UE. In the R17 NTN project, the UEs are all assumed to have Global Navigation Satellite System (GNSS) capabilities, and for the transparent payload NTN architecture, the UEs are able to determine service link TAs by themselves based on localization capabilities and ephemeris information of a service satellite and carry out TA adjustments based on this. In this way, the network may have no idea of actual TAs used by the UEs. In order to assist the network to perform a K offset configuration for the UE, a mechanism of the UE reporting the TA is introduced in the NTN.

For the TA reporting, the following conclusions (1) and (2) have been developed currently.

(1) whether the UE can report the TA in an initial RACH process depends on a network configuration, and the network configures the indication information by means of broadcasting.

(2) the UE in the RRC connection state supports an event-triggering TA reporting mechanism. Currently-agreed triggering events of the TA reporting include the network configuring a TA offset threshold, and the UE triggering the TA reporting in response to the variation of a current TA value of the UE compared to a TA value which is successfully reported at last time exceeding the TA offset threshold.

Based on the conclusions of current meetings, for event-triggering TA reporting, the UE is required to compare the current TA value with a lastly-reported TA value to determine whether to trigger the TA reporting. How to trigger the TA reporting under this TA reporting mechanism is a problem required to be solved.

The technical solutions of the embodiments of the present disclosure may be applied to various communication systems, such as a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced long term evolution (LTE- A) system, a New Radio (NR) system, an evolution system of the NR system, a LTE-based access to unlicensed spectrum (LTE-U) system, a NR-based access to unlicensed spectrum (NR-U) system, a Non-Terrestrial Network (NTN) system, a Universal Mobile Telecommunication System (UMTS), a Wireless Local Area Network (WLAN), Wireless Fidelity (WiFi), a 5th-generation communication (5th-Generation, 5G) system, or other communication systems, etc.

In general, the number of connections supported by traditional communication systems is limited and also easy to be implemented. However, with the development of communication technologies, mobile communication systems will not only support traditional communications, but also support, e.g., a (Device-to-device) (D2D) communication, a Machine to Machine (M2M) communication, a Machine Type Communication (MTC), a Vehicle to Vehicle (V2V) communication, or a Vehicle to everything (V2X)) communication, etc. The embodiments of the present disclosure may also be applied to these communication systems.

In some embodiments, the communication system in the embodiments of the present disclosure may be applied to a Carrier Aggregation (CA) scenario, or may also be applied to a Dual Connectivity (DC) scenario, or may also be applied to a Standalone (SA) network deployment scenario.

In some embodiments, the communication system in the embodiments of the present disclosure may be applied to an unlicensed spectrum. The unlicensed spectrum may also be considered to be a shared spectrum. Alternatively, the communication system in the embodiments of the present disclosure may also be applied to a Licensed spectrum. The licensed spectrum may also be considered to be an unshared spectrum.

Each embodiment is described in combination with a terminal device and a network device in the embodiments of the present disclosure. The terminal device may also be referred to as the user equipment (UE), an access terminal, a user unit, a user station, a mobile station, a remote station, a remote terminal, a mobile device, a user terminal, a terminal, a wireless communication device, a user agent, or a user apparatus, etc.

The terminal device may be a STATION (ST) in the WLAN, or may be a cellular phone, a cordless phone, a session initiation protocol (SIP) phone, a wireless local loop (WLL) station, a personal digital assistant (PDA) device, a handheld device having a wireless communication function, a computing device, or other processing devices connected to a wireless modem, an in- vehicle device, a wearable device, a terminal device in a next generation communication system such as a NR network, or a terminal device in a future-evolved public land mobile network (PLMN), or the like.

In the embodiments of the present disclosure, the terminal device may be deployed on land which includes indoor or outdoor, handheld, wearable, or vehicle-mounted cases. The terminal device may also be deployed on water (e.g., a ship, etc.), and may also be deployed in the air (e.g., on an aircraft, a balloon, or a satellite, etc.).

In the embodiments of the present disclosure, the terminal device may be a Mobile Phone, a Pad, a computer with a wireless transceiving function, a virtual reality (VR) terminal device, an augmented reality (AR) terminal device, a wireless terminal device under an industrial control, a wireless terminal device in self driving, a wireless terminal device in a remote medical, a wireless terminal device in a smart grid, a wireless terminal devices in transportation safety, and a wireless terminal device in a smart city or a wireless terminal device in a smart home, etc.

As an example, not a limitation, in the embodiments of the present disclosure, the terminal device may also be the wearable device. The wearable device may also be referred to as a wearable smart device, which is a general term of wearable devices obtained by intelligently designing and developing daily wears, such as glasses, gloves, watches, clothing, and shoes, etc., by means of wearable techniques. The wearable devices are directly worn on a body or integrated into the clothing or an accessory of the user as a portable device. The wearable devices are more than hardware devices, may also achieve powerful functions thereof through software supports, data interactions, and cloud interactions. The wearable smart device in a broad sense includes a device having full features, a large size, and capable of achieving entire or partial functions independent of a smartphone, e.g., a smart watch, or smart glasses, etc., and a device only concentrating on a particular category of application function and required to cooperate with other devices such as the smartphone, e.g., various smart bracelets configured to monitor signs, a smart jewelry, or the like.

In the embodiments of the present disclosure, the network device may be a device configured to communicate with the terminal device. The network device may be an Access Point (AP) in the WLAN, a base transceiver station (BTS) in the GSM or CDMA system, or a NodeB (NB) in the WCDMA system, or an evolutional NodeB (eNB or eNodeB) in the LTE system, or may be a relay station, the access point, the in-vehicle device, the wearable device. and a network device (gNB) in the NR network, or a network device in the future-evolved PLMN network, or a network device in the NTN network.

As an example, not a limitation, in the embodiments of the present disclosure, the network device may have a mobile characteristic. For example, the network device may be a mobile device. In an embodiment, the network device may be the satellite, a balloon station. For example, the satellite may be the Low Earth Orbit (LEO) satellite, the medium earth orbit (MEO) satellite, the geostationary earth orbit (GEO) satellite, the High Elliptical Orbit (HEO) satellite, etc. In an embodiment, the network device may also be a base station installed on a location such as the land, the water, etc.

In the embodiments of the present disclosure, the network device may provide service for a cell. The terminal device communicates with the network device through a transmission resource (e.g., a frequency domain resource, or in other words, a spectrum resource) employed by the cell. The cell may be a cell corresponding to the network device (such as, the base station). The cell may belong to a macro base station or a base station corresponding to a small cell. The small cell herein may include a Metro cell, a Micro cell, a Pico cell, a Femto cell, etc. These small cells have characteristics of a small coverage area and a low transmission power, and are suitable to provide a high-speed data transmission service.

As shown in FIG. 6, FIG. 6 is a system architecture diagram of a communication system applied in the embodiments of the present disclosure. The communication system may include a network device. The network device may be a device communicating with a terminal device (also referred to as a communication terminal or the terminal). The network device may provide a communication coverage for a particular geographical region and may communicate with terminal devices located in the coverage region. FIG. 6 exemplarily shows one network device and two terminal devices. In some embodiments, the communication system may include multiple network devices and a coverage scope of each of the multiple network devices may include other numbers of terminal devices, which is not limited in the present disclosure. In some embodiments, the communication system may also include other network entities such as a network controller and a mobility management entity, etc., which is not limited in the embodiments of the present disclosure.

The network device may include an access network device and a core network device. That is, the wireless communication system may include multiple core networks configured to communicate with the access network device. The access network device may be the evolutional NodeB (or the eNB or eNodeB for short), the macro base station, a micro base station (also referred to as a small base station), a pico base station, the access point (AP), a transmission point (TP), or a new generation NodeB (gNodeB), etc., in the LTE system, the NR system or an authorized auxiliary access long-term evolution (LAA-LTE) system.

It should be understood that a device having a communication function in the network/system in the embodiments of the present disclosure may be referred to as the communication device. The communication system shown in FIG. 6 is taken as an example, the communication device may include the network device and the terminal devices which have communication functions. The network device and the terminal devices may be concrete devices described in the embodiments of the present disclosure, which are not repeated herein. The communication device may also include other devices in the communication system, e.g., other network entities such as the network controller, the mobility management entity, etc., which are not limited in the embodiments of the present disclosure.

The technical solutions of the present disclosure are further described in a manner of embodiments. As shown in FIG. 7, FIG. 7 is a schematic view of a method of the terminal device reporting the timing advance in the NTN in the embodiments of the present disclosure. The method includes operations 701-702.

In an operation 701, the method includes the network device transmitting a TA reporting event configuration/reconfiguration message, or a TA reporting function configuration/reconfiguration message to the terminal device in a Radio Access Control RRC connection state. The TA reporting event configuration/reconfiguration message is configured for the terminal device to trigger TA reporting based on a TA reporting event, and the TA reporting function configuration/reconfiguration message is configured for the terminal device to trigger the TA reporting based on a TA reporting function.

In some embodiments, the TA reporting function configuration/reconfiguration message includes the TA reporting event and/or periodically reporting.

In some embodiments, the TA reporting event includes a variation amount of a current TA value of the terminal device relative to a TA value reported at a latest time being greater than or equal to a TA offset threshold. That is, the variation amount of a current TA value of the UE relative to the TA value reported at the latest time is greater than or equal to the TA offset threshold.

In some embodiments, the TA offset threshold is configured for event-triggering TA reporting, the TA offset threshold is configured for the terminal device to estimate whether the variation amount between the current TA value of the terminal device and the TA value reported at the latest time exceeds the TA offset threshold.

It can be understood that in a case of the terminal device estimating that the variation amount between the current TA value and the TA value reported at the latest time exceeds the TA offset threshold, the terminal device triggers the TA reporting.

In some embodiments, the TA offset threshold is configured by a network device.

In an operation 702, the method includes the terminal device triggering the TA reporting in response to the terminal device in the RRC connection state receiving the TA reporting event configuration/reconfiguration message from the network device, or receiving the TA reporting function configuration/reconfiguration message from the network device.

In some embodiments, the operation of the terminal device triggering the TA reporting in response to the terminal device in the RRC connection state receiving the TA reporting function configuration/reconfiguration message from the network device includes the terminal device triggering the TA reporting, in response to the terminal device in the RRC connection state receiving the TA reporting function configuration/reconfiguration message from the network device and the TA reporting function configuration/reconfiguration message indicating the terminal device to turn on or maintain the TA reporting function.

In some embodiments, the terminal device turns on the TA reporting function and triggers the TA reporting based on the TA reporting event in a case of the TA reporting function configuration/reconfiguration message including the TA reporting event.

In some embodiments, the terminal device turns on the TA reporting function and periodically triggers the TA reporting in a case of the TA reporting function configuration/reconfiguration message including the periodically reporting.

In some embodiments, the terminal device triggering the TA reporting in response to the terminal device in the RRC connection state receiving the TA reporting event configuration/reconfiguration message from the network device may include but is not limited to the following implementation manners (1)-(2).

(1) the terminal device triggers the TA reporting in a case of the terminal device having reported the TA, or the terminal device having not reported the TA, in response to the terminal device in the RRC connection state receiving the TA reporting event configuration/reconfiguration message from the network device.

It can be understood that when the UE in the RRC connection state receives the TA reporting event configuration/reconfiguration message from the network device, UE triggers the TA reporting regardless of whether the UE has reported the TA to the network device before. The term “before” herein may be appreciated as before the terminal device receives the TA reporting event configuration/reconfiguration message from the network device. That is, when the UE in the RRC connection state receives the TA reporting event configuration/reconfiguration message from the network device, UE triggers the TA reporting regardless of whether the UE has reported the TA to the network device before the terminal device receives the TA reporting event configuration/reconfiguration message from the network device.

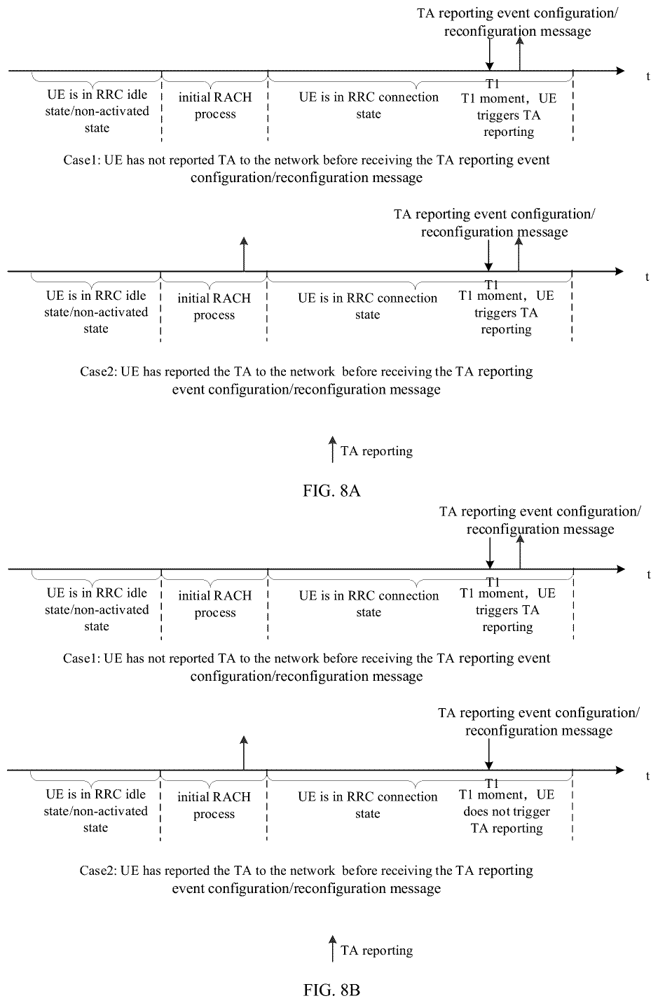

Exemplarily, as shown in FIG. 8A, FIG. 8A is a schematic view of the terminal device reporting the timing advance in the NTN according to some embodiments of the present disclosure. The UE in the RRC connection state receives the TA reporting event configuration/reconfiguration message from the network device. When the UE receives the TA reporting event configuration/reconfiguration message, the UE triggers the TA reporting regardless of whether the UE has reported the TA to the network device. That is, even if the UE has reported the TA to the network device in a RACH process, or the UE has reported the TA to the network device after entering the RRC connection state, the UE triggers the TA reporting when receiving the TA reporting event configuration/reconfiguration message.

(2) in response to the terminal device in the RRC connection state receiving the TA reporting event configuration/reconfiguration message from the network device, the terminal device triggers the TA reporting, in the case of the terminal device having not reported the TA; the terminal device does not trigger the TA reporting, in the case of the terminal device having reported the TA.

It can be understood that when the UE in the RRC connection state receives the TA reporting event configuration/reconfiguration message from the network device, if the UE has not reported the TA to the network device before, the UE triggers the TA reporting. The term “before” may be construed as herein may be construed as before the terminal device receives the TA reporting event configuration/reconfiguration message from the network device. That is, when the UE in the RRC connection state receives the TA reporting event configuration/reconfiguration message from the network device, if the UE has not ever reported the TA to the network device before the terminal device receives the TA reporting event configuration/reconfiguration message from the network device, the UE triggers the TA reporting.

Exemplarily, as shown in FIG. 8B, FIG. 8B is a schematic view of the terminal device reporting the timing advance in the NTN according to some embodiments of the present disclosure. The UE in the RRC connection state receives the TA reporting event configuration/reconfiguration message from the network device. When the UE receives the TA reporting event configuration/reconfiguration message, if the UE has not ever reported the TA to the network device, the UE triggers the TA reporting. Otherwise (e.g., the UE has reported the TA to the network device in the RACH process, or the UE has reported the TA to the network device after entering the RRC connection state receiving the TA reporting event configuration/reconfiguration message), the UE does not trigger the TA reporting.

In some embodiments, the terminal device having reported the TA includes the terminal device having reported the TA to the network device in the Random Access Channel RACH process; or the terminal device having reported the TA to the network device after entering the RRC connection state.

Understandably, before the terminal device receives the TA reporting event configuration/reconfiguration message from the network device may be the terminal device being in the RACH process, or may also be after the terminal device enters the RRC connection state, which is not limited herein.

In some embodiments, the TA includes an actual TA of the terminal device, or a TA amount related to the actual TA of the terminal device.

In some embodiments, the TA amount related to the actual TA of the terminal device may be one or multiple.

It can be understood that, the actual TA of the terminal device indicates a TA actually used by the terminal device. The TA amount related to the actual TA of the terminal device indicates an amount derived from the TA actually used by the terminal device.

In the embodiments of the present disclosure, the terminal device triggers the TA reporting in response to the terminal device in the RRC connection state receiving the TA reporting event configuration/reconfiguration message from the network device, or receiving the TA reporting function configuration/reconfiguration message from the network device. In this way, the problem of how the UE triggers the TA reporting under the event-based TA reporting mechanism is addressed. When the UE in the RRC connection state receives the TA reporting event configuration/reconfiguration message from the network device, UE triggers the TA reporting regardless of whether the UE has reported the TA to the network device before. Alternatively, when the UE in the RRC connection state receives the TA reporting event configuration/reconfiguration message from the network device, if the UE has not reported the TA to the network device before, the UE triggers the TA reporting.

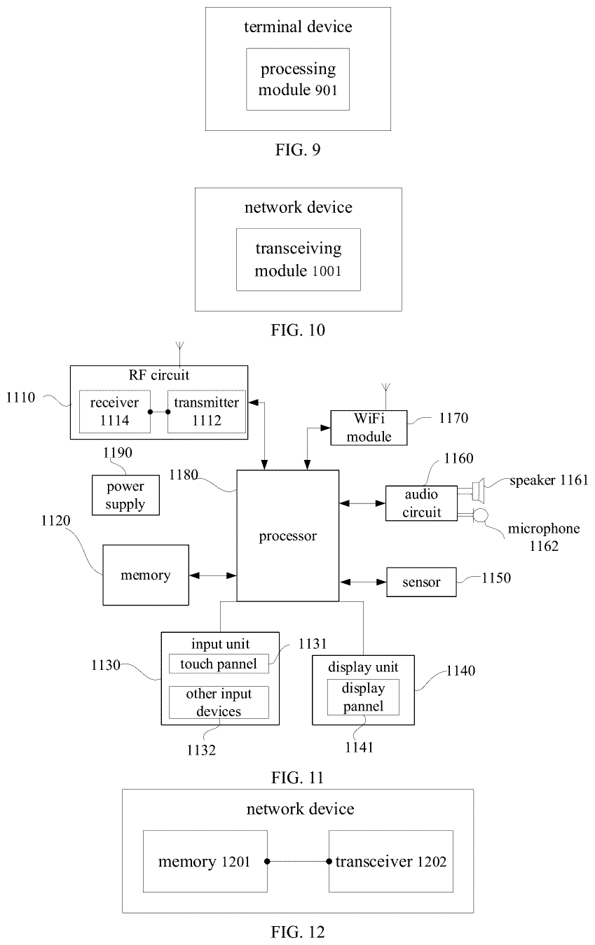

As shown in FIG. 9, FIG. 9 is a schematic view of the terminal device according to an embodiment of the present disclosure. The terminal device may include a processing module 901.

The processing module 901 is configured to trigger TA reporting in response to the terminal device in a Radio Access Control RRC connection state receiving a TA reporting event configuration/reconfiguration message from a network device, or receiving a TA reporting function configuration/reconfiguration message from the network device.

In some embodiments, the TA reporting function configuration/reconfiguration message includes a TA reporting event and/or periodically reporting.

In some embodiments, the processing module 901 is configured to trigger the TA reporting, in response to the terminal device in the RRC connection state receiving the TA reporting function configuration/reconfiguration message from the network device and the TA reporting function configuration/reconfiguration message indicating the terminal device to turn on or maintain a TA reporting function.

In some embodiments, the TA reporting event includes a variation amount of a current TA value of the terminal device relative to a TA value reported at a latest time being greater than or equal to a TA offset threshold.

In some embodiments, the TA offset threshold is configured for event-triggering TA reporting, the TA offset threshold is configured for the terminal device to estimate whether the variation amount between the current TA value of the terminal device and the TA value reported at the latest time exceeds the TA offset threshold.

In some embodiments, the TA offset threshold is configured by the network device.

In some embodiments, the processing module 901 is configured to trigger the TA reporting, in a case of the terminal device having reported the TA, or the terminal device having not reported the TA, in response to the terminal device in the RRC connection state receiving the TA reporting event configuration/reconfiguration message from the network device.

In some embodiments, in response to the terminal device in the RRC connection state receiving the TA reporting event configuration/reconfiguration message from the network device, the processing module 901 is configured to trigger the TA reporting in a case of the terminal device having not reported the TA; and the processing module 901 is configured not to trigger the TA reporting, in a case of the terminal device having reported the TA.

In some embodiments, the terminal device having reported the TA includes the terminal device having reported the TA to the network device in a RACH process; or the terminal device having reported the TA to the network device after entering the RRC connection state.

In some embodiments, the TA includes an actual TA of the terminal device, or a TA amount related to the actual TA of the terminal device.

As shown in FIG. 10, FIG. 10 is a schematic view of a network device according to an embodiment of the present disclosure. The network device includes a transceiving module 1001.

The transceiving module 1001 is configured to transmit a TA reporting event configuration/reconfiguration message, or a TA reporting function configuration/reconfiguration message to a terminal device in a Radio Access Control RRC connection state, wherein the TA reporting event configuration/reconfiguration message is configured for the terminal device to trigger TA reporting based on a TA reporting event, and the TA reporting function configuration/reconfiguration message is configured for the terminal device to trigger the TA reporting based on a TA reporting function.

In some embodiments, the TA reporting function configuration/reconfiguration message includes the TA reporting event and/or periodically reporting.

In some embodiments, the TA reporting event includes a variation amount of a current TA value of the terminal device relative to a TA value reported at a latest time being greater than or equal to a TA offset threshold.

In some embodiments, the TA offset threshold is configured for event-triggering TA reporting, the TA offset threshold is configured for the terminal device to estimate whether the variation amount between the current TA value of the terminal device and the TA value reported at the latest time exceeds the TA offset threshold.

In some embodiments, the TA offset threshold is configured by the network device.

Corresponding to the above-described method applied to the embodiments of the terminal device, the embodiments of the present disclosure further provide one or more kind of terminal device. The terminal device of the embodiments of the present disclosure may perform any one of implementation manners of the above-described method. As shown in FIG. 11, FIG. 11 is a schematic view of the terminal device according to another embodiment of the present disclosure. The terminal device is illustrated with the mobile phone as an example, which may include components, such as, a radio frequency (RF) circuit 1110, a memory 1120, an input unit 1130, a display unit 1140, a sensor 1150, an audio circuit 1160, a wireless fidelity (WiFi) module 1170, a processor 1180, and a power supply 1190, and the like. The RF circuit 1110 includes a receiver 1114 and a transmitter 1112. Those skilled in the art may understand that a structure of the mobile phone shown in FIG. 11 does not constitute limitations to the mobile phone. The mobile phone may include more or fewer components, or combine some components, or have different component arrangements.

Each component of the mobile phone is described in detail below in connection with FIG. 11.

The RF circuit 1110 may be configured to receive and transmit signals during receiving and transmitting information or calling. In particular, when the downlink information of the base station is received, the downlink information is provided to the processor 1180 for processing. In addition, uplink-involved data is transmitted to the base station. In general, the RF circuit 1110 includes but not limited to an antenna, at least one amplifier, a transceiver, a coupler, a low noise amplifier (LNA), a duplexer, and the like. In addition, the RF circuit 1110 may communicate with the network and other devices via wireless communication. The above-mentioned wireless communication may employ any one of the communication standards or protocols, which include but are not limited to global system of mobile communication (GSM), general packet radio service (GPRS), code division multiple access (CDMA), wideband code division multiple access (WCDMA), long term evolution (LTE), e-mail, short messaging service (SMS), etc.

The memory 1120 may be configured to store software programs and modules. The processor 1180 executes various functional applications and data processing of the mobile phone through running the software programs and modules stored in the memory 1120. The memory 1120 may primarily include a storage program area and a storage data area. The storage program area may store an operating system, an application required for at least one function (e.g., a sound playback function, an image playback function, etc.), etc. The storage data area may store data created based on the use of the mobile phone (e.g., audio data, a telephone book, etc.), etc. In addition, the memory 1120 may include a cache random access memory, and may also include a non-volatile memory, such as at least one disk memory device, a flash memory device, or other volatile solid-state memory devices.

The input unit 1130 may be configured to receive an inputted numeric or character information, and to generate a key signal input related to user setting and function control of the mobile phone. The input unit 1130 may include a touch panel 1131 and other input devices 1132. The touch panel 1131, also referred to as a touch screen, may collect touch operations of a user on or near it (e.g., an operation of a user using any suitable object or attachment such as a finger, a stylus, or the like, on or near the touch panel 1131), and to drive a corresponding connection apparatus according to a predetermined program. In an embodiment, the touch panel 1131 may include two parts, i.e., a touch detection apparatus and a touch controller. The touch detection apparatus detects a touch orientation of the user and detects a signal brought by the touch operation, and transmits the signal to the touch controller. The touch controller receives touch information from the touch detection apparatus and converts it into contact coordinates, and then transmits the contact coordinates to the processor 1180. The touch controller is capable of receiving a command from the processor 1180 and executing them. In addition, the touch panel 1131 may be implemented through multiple types, such as, a resistive form, a capacitive form, an infrared form, and a surface acoustic wave form. In addition to the touch panel 1131, the input unit 1130 may also include other input devices 1132. For example, the other input devices 1132 may include, but are not limited to, one or more of a physical keyboard, a function key (such as a volume control key, an on/off key, and the like), a trackball, a mouse, a joystick, etc.

The display unit 1140 may be configured to display information entered by the user or information provided to the user and various menus of the mobile phone. The display unit 1140 may include a display panel 1141. In an embodiment, the display panel 1141 may be configured through a form, such as, a liquid crystal display (LCD), an organic light-emitting diode (OLED), etc. Further, the touch panel 1131 may cover the display panel 1141. When the touch panel 1131 detects a touch operation on or near it, the touch panel transmits he touch operation to the processor 1180 to determine a type of a touch event. Subsequently, the processor 1180 provides a corresponding visual output on the display panel 1141 based on the type of the touch event. Although in FIG. 11, the touch panel 1131 and the display panel 1141 implement an input function and an output function of the mobile phone as two independent or separate components, in some embodiments, the touch panel 1131 and the display panel 1141 are integrated to implement the input function and the output function of the mobile phone.

The mobile phone may also include at least one sensor 1150, such as a light sensor, a motion sensor, and other sensors. In some embodiments, the light sensor may include an ambient light sensor and a proximity sensor. The ambient light sensor adjusts a brightness of the display panel 1141 according to a brightness of ambient light. The proximity sensor turns off the display panel 1141 and/or backlight when the mobile phone is moved to an ear. As a type of the motion sensor, an accelerometer sensor may detect a magnitude of an acceleration in each direction (generally three axes), and may detect a magnitude and a direction of a gravity when stationary, which may be used for an application (such as horizontal and vertical screen switching, related games, magnetometer attitude calibration) of identifying attitudes of the mobile phone, vibration identification related functions (such as a pedometer, tapping), and the like. The mobile phone may also be configured with a gyroscope, a barometer, a barometer, a thermometer, an infrared sensor, and other sensors, which is not repeated herein.

The audio circuit 1160, a speaker 1161, and a microphone 1162 may provide an audio interface between the user and the mobile phone. The audio circuit 1160 may transmit an electrical signal converted from a received audio data to the speaker 1161. The electrical signal is converted into a sound signal by the speaker 1161 to be outputted. On the other hand, the microphone 1162 converts a collected sound signal into an electrical signal which is converted to audio data after received by the audio circuit 1160. The audio data is outputted to the processor 1180 to be processed. Processed audio data is then transmitted to, e.g., another mobile phone, via the RF circuit 1110, or is outputted to the memory 1120 for further processing.

WiFi belongs to a short-range wireless transmission technology. The mobile phone may help the user to send and receive emails, browse the web, and access streaming media through the WiFi module 1170 which provides the user with wireless wideband Internet access. Although the WiFi module 1170 is illustrated in FIG. 11, understandably, it is not a mandatory constituent of the mobile phone, and may be completely omitted according to needs within a scope of not changing an essence of the present disclosure.

The processor 1180 is a control center of the mobile phone, and is connected to various portions of the mobile phone by virtue of various kinds of interfaces and lines. The processor 1180 executes various functions and processes data through running or performing a soft program and/or module stored in the memory 1120 and calling data stored in the memory 1120, so as to perform overall monitoring for the mobile phone. In some embodiments, the processor 1180 may include one or more processing units. In an embodiment, the processor 1180 may integrate an application processor and a modem processor. The application processor primarily handles the operating system, a user interface, and an application program, etc. The modem processor primarily handles the wireless communication. It will be appreciated that the modem processor described above may also not be integrated into the processor 1180.

The mobile phone also includes the power supply 1190 (e.g., a battery) which supplies power to the various components. In an embodiment, the power supply may be logically connected to the processor 1180 via a power management system, so as to achieve a function such as charging management, discharging management, and power consumption management, etc., via the power management system. Although not shown, the mobile phone may also include a camera, a Bluetooth module, and the like, which will not be described herein.

In the embodiments of the present disclosure, the processor 1180 is configured to trigger TA reporting in response to the terminal device in a Radio Access Control RRC connection state receiving a TA reporting event configuration/reconfiguration message from a network device, or receiving a TA reporting function configuration/reconfiguration message from the network device.

In some embodiments, the TA reporting function configuration/reconfiguration message includes a TA reporting event and/or periodically reporting.

In some embodiments, the processor 1180 is configured to turn on the TA reporting function and trigger the TA reporting, in response to the terminal device in the RRC connection state receiving the TA reporting function configuration/reconfiguration message from the network device and the TA reporting function configuration/reconfiguration message indicating the terminal device to turn on or maintain a TA reporting function.

In some embodiments, the TA reporting event includes a variation amount of a current TA value of the terminal device relative to a TA value reported at a latest time being greater than or equal to a TA offset threshold.

In some embodiments, the TA offset threshold is configured for event-triggering TA reporting, the TA offset threshold is configured for the terminal device to estimate whether the variation amount between the current TA value of the terminal device and the TA value reported at the latest time exceeds the TA offset threshold.

In some embodiments, the TA offset threshold is configured by the network device.

In some embodiments, the processor 1180 is configured to trigger the TA reporting, in a case of the terminal device having reported the TA, or the terminal device having not reported the TA, in response to the terminal device in the RRC connection state receiving the TA reporting event configuration/reconfiguration message from the network device.

In some embodiments, in response to the terminal device in the RRC connection state receiving the TA reporting event configuration/reconfiguration message from the network device, the processor 1180 is configured to trigger the TA reporting in a case of the terminal device having not reported the TA; and the processor 1180 is configured not to trigger the TA reporting, in a case of the terminal device having reported the TA.

In some embodiments, the terminal device having reported the TA includes the terminal device having reported the TA to the network device in a RACH process; or the terminal device having reported the TA to the network device after entering the RRC connection state.

In some embodiments, the TA includes an actual TA of the terminal device, or a TA amount related to the actual TA of the terminal device.

As shown in FIG. 12, FIG. 12 is a schematic view of the network device according to another embodiment of the present disclosure. The network device includes a memory 1201 and a transceiver 1202.

The memory 1201 stores executable program codes.

The transceiver 1202 is coupled to the memory 1201.

The transceiver 1202 is configured to transmit a TA reporting event configuration/reconfiguration message, or a TA reporting function configuration/reconfiguration message to a terminal device in a Radio Access Control RRC connection state, wherein the TA reporting event configuration/reconfiguration message is configured for the terminal device to trigger TA reporting based on a TA reporting event, and the TA reporting function configuration/reconfiguration message is configured for the terminal device to trigger the TA reporting based on a TA reporting function.

In some embodiments, the TA reporting function configuration/reconfiguration message includes the TA reporting event and/or periodically reporting.

In some embodiments, the TA reporting event includes a variation amount of a current TA value of the terminal device relative to a TA value reported at a latest time being greater than or equal to a TA offset threshold.

In some embodiments, the TA offset threshold is configured for event-triggering TA reporting, the TA offset threshold is configured for the terminal device to estimate whether the variation amount between the current TA value of the terminal device and the TA value reported at the latest time exceeds the TA offset threshold.

In some embodiments, the TA offset threshold is configured by the network device.

The above embodiments may be achieved in whole or in part through a software, a hardware, a firmware, or any combination thereof. When implemented by the software, it may be implemented in whole or in part in a form of a computer program product. The computer program product includes one or more computer instructions. When the computer instructions are loaded and executed in a computer, a flow or functions described in accordance with the embodiments of the present disclosure is generated in whole or in part. The computer may be a general-purpose computer, a specialized computer, a computer network, or other programmable apparatus. The computer instructions may be stored in a computer-readable storage medium or transmitted from one computer-readable storage medium to another computer-readable storage medium. For example, the computer instructions may be transmitted from a website site, a computer, a server, or a data center to another website site, another computer, another server, or another data center in a wired manner (e.g., a coaxial cable, a fiber optic, and a digital subscriber line (DSL)) or a wireless manner (e.g., infrared, wireless, microwave, etc.). The computer-readable storage medium may be any available medium storable in the computer or a data storage device such as the server, the data center, etc., integrated by one or more available media. The available medium may be a magnetic medium (e.g., a floppy disk, a hard disk, a magnetic tape), an optical medium (e.g., DVD), or a semiconductor medium (e.g., a Solid State Disk (SSD)), etc.

Terms “first”, “second”, “third”, and “fourth”, etc. in the specification, claims of the present disclosure, and the accompanying drawings above (when existing therein) are configured to distinguish similar objects and are not necessary to be configured to describe a particular order or sequence. It should be understood that features with these terms mentioned above may be interchangeable in an appropriate case, such that the embodiments described herein may be implemented in an order other than that illustrated or described herein. In addition, the terms “include” and “have” and any variations thereof are intended to cover non-exclusive inclusion. For example, a process, method, system, product, or apparatus including a series of steps or units are not necessary to be limited to those steps or units which are clearly listed, but may include those steps or units which are not clearly listed, or other steps or units inherent to the above process, method, product, or device.

What is claimed is:

1. A method of a terminal device reporting a Timing Advance TA in a Non Terrestrial Network NTN, comprising:
triggering TA reporting, by the terminal device, in response to the terminal device in a Radio Access Control RRC connection state receiving a TA reporting event configuration/reconfiguration message from a network device, or receiving a TA reporting function configuration/reconfiguration message from the network device.

2. The method according to claim 1, wherein a TA reporting event comprises a variation amount of a current TA value of the terminal device relative to a TA value reported at a latest time being greater than or equal to a TA offset threshold.

3. The method according to claim 2, wherein the TA offset threshold is configured for event-triggering TA reporting, the TA offset threshold is configured for the terminal device to estimate whether the variation amount between the current TA value and the TA value reported at the latest time exceeds the TA offset threshold.

4. The method according to claim 2, wherein the TA offset threshold is configured by the network device.

5. The method according to claim 1, wherein the triggering TA reporting, by the terminal device, in response to the terminal device in a RRC connection state receiving a TA reporting event configuration/reconfiguration message from a network device, comprises:
triggering, by the terminal device, the TA reporting, in a case of the terminal device having reported the TA, or the terminal device having not reported the TA, in response to the terminal device in the RRC connection state receiving the TA reporting event configuration/reconfiguration message from the network device.

6. The method according to claim 1, wherein the triggering TA reporting, by the terminal device, in response to the terminal device in a RRC connection state receiving a TA reporting event configuration/reconfiguration message from a network device, comprises:
in response to the terminal device in the RRC connection state receiving the TA reporting event configuration/reconfiguration message from the network device, triggering, by the terminal device, the TA reporting, in a case of the terminal device having not reported the TA; not triggering, by the terminal device, the TA reporting, in a case of the terminal device having reported the TA.

7. The method according to claim 5, wherein the terminal device having reported the TA comprises:
the terminal device having reported the TA to the network device in a Random Access Channel RACH process; or
the terminal device having reported the TA to the network device after entering the RRC connection state.

8. The method according to claim 1, wherein the TA comprises an actual TA of the terminal device, or a TA amount related to the actual TA of the terminal device.

9. A method of a terminal device reporting a Timing Advance TA in a Non Terrestrial Network NTN, comprising:
transmitting, by a network device, a TA reporting event configuration/reconfiguration message, or a TA reporting function configuration/reconfiguration message to a terminal device in a Radio Access Control RRC connection state, wherein the TA reporting event configuration/reconfiguration message is configured for the terminal device to trigger TA reporting based on a TA reporting event, and the TA reporting function configuration/reconfiguration message is configured for the terminal device to trigger the TA reporting based on a TA reporting function.

10. The method according to claim 9, wherein a TA reporting event comprises a variation amount of a current TA value of the terminal device relative to a TA value reported at a latest time being greater than or equal to a TA offset threshold.

11. The method according to claim 10, wherein the TA offset threshold is configured for event-triggering TA reporting, the TA offset threshold is configured for the terminal device to estimate whether the variation amount between the current TA value and the TA value reported at the latest time exceeds the TA offset threshold.

12. A terminal device, comprising:
a memory, storing executable program codes; and
a processor, coupled to the memory, and configured to trigger TA reporting in response to the terminal device in a Radio Access Control RRC connection state receiving a TA reporting event configuration/reconfiguration message from a network device, or receiving a TA reporting function configuration/reconfiguration message from the network device.

13. The terminal device according to claim 12, wherein a TA reporting event comprises a variation amount of a current TA value of the terminal device relative to a TA value reported at a latest time being greater than or equal to a TA offset threshold.

14. The terminal device according to claim 13, wherein the TA offset threshold is configured for event-triggering TA reporting, the TA offset threshold is configured for the terminal device to estimate whether the variation amount between the current TA value and the TA value reported at the latest time exceeds the TA offset threshold.

15. The terminal device according to claim 12, wherein the processor is configured to trigger the TA reporting, in a case of the terminal device having reported the TA, or the terminal device having not reported the TA, in response to the terminal device in the RRC connection state receiving the TA reporting event configuration/reconfiguration message from the network device.

16. The terminal device according to claim 12, wherein in response to the terminal device in the RRC connection state receiving the TA reporting event configuration/reconfiguration message from the network device, the processor is configured to trigger the TA reporting in a case of the terminal device having not reported the TA; and the processor is configured not to trigger the TA reporting, in a case of the terminal device having reported the TA.

17. The terminal device according to claim 15, wherein the terminal device having reported the TA comprises:
the terminal device having reported the TA to the network device in a RACH process; or
the terminal device having reported the TA to the network device after entering the RRC connection state.

18. The terminal device according to claim 12, wherein the TA comprises an actual TA of the terminal device, or a TA amount related to the actual TA of the terminal device.

19. A network device, comprising:
a memory, storing executable program codes; and
a transceiver, coupled to the memory, and configured to transmit a TA reporting event configuration/reconfiguration message, or a TA reporting function configuration/reconfiguration message to a terminal device in a Radio Access Control RRC connection state, wherein the TA reporting event configuration/reconfiguration message is configured for the terminal device to trigger TA reporting based on a TA reporting event, and the TA reporting function configuration/reconfiguration message is configured for the terminal device to trigger the TA reporting based on a TA reporting function.

20. The network device according to claim 19, wherein a TA reporting event comprises a variation amount of a current TA value of the terminal device relative to a TA value reported at a latest time being greater than or equal to a TA offset threshold;
wherein the TA offset threshold is configured by the network device.
